(19) United States
(12) Patent Application Publication
(10) Pub. No.: US 2013/0221889 A1
(43) Pub. Date: Aug. 29, 2013

(54) MULTI-PHASE SWITCHED RELUCTANCE MOTOR APPARATUS AND CONTROL METHOD THEREOF

(71) Applicant: Samsung Electro-Mechanics Co., Ltd., (US)

(72) Inventors: Changsung Sean Kim, Suwon (KR); Han Kyung Bae, Suwon (KR); Guen Hong Lee, Suwon (KR)

(73) Assignee: SAMSUNG ELECTRO-MECHANICS CO., LTD., Suwon (KR)

(21) Appl. No.: 13/774,846

(22) Filed: Feb. 22, 2013

(30) Foreign Application Priority Data
Feb. 23, 2012 (KR) 10-2012-0018647

(51) Int. Cl. H02P 6/00; H02K 1/12

(52) U.S. Cl. CPC H02P 6/002; H02K 1/12
USPC 318/400.37; 310/48

(57) ABSTRACT

Disclosed herein is a multi-phase switched reluctance motor apparatus including: a multi-phase switched reluctance motor; a position sensing sensor provided at one side of the multi-phase switched reluctance motor; and a controller connected to the multi-phase switched reluctance motor and the position sensing sensor and controlling power in a multi-phase excitation scheme according to a detection angle of the position sensing sensor to supply the power to the multi-phase switched reluctance motor. The multi-phase switched reluctance motor may generate a reluctance torque while reducing torque pulsation, noise, and vibration.

### CROSS REFERENCE TO RELATED APPLICATION

This application claims the benefit of Korean Patent Application No. 10-2012-0018647, filed on Feb. 23, 2012, entitled “Multi-Phase Switched Reluctance Motor Apparatus and Control Method Thereof”, which is hereby incorporated by reference in its entirety into this application.

### BACKGROUND OF THE INVENTION

1. Technical Field

The present invention relates to a multi-phase switched reluctance motor apparatus and a control method thereof.

2. Description of the Related Art

Recently, the demand for a motor has largely increased in various industries such as vehicles, aerospace, military, medical equipment, or the like. In particular, a cost of a motor using a permanent magnet is increased due to the sudden price increase of a rare earth material, such that a switched reluctance motor has again become prominent as a new alternative.

The switched reluctance motor (SRM) has a form in which it does not include a brush and has advantages such as a simple structure, firmness, high efficiency, and a low manufacturing cost, as described in Korean Patent No. 10-0600540 (registered on Jul. 6, 2006). Due to these advantages and the development of a power electronics technology, the SRM has been recently spotlighted significantly. The SRM having a structure in which a stator and a rotor are configured as a double salient pole has a reluctant torque generated depending on a magnetic structure when excitation energy is applied to the stator and has characteristics in which reluctance at a phase at which the excitation energy is applied is minimized.

A design principle of the SRM had a basic form prepared by Byrne, Lawrenson, and the like, and has been arranged by Miller, and the like. According to the prior art, research into a design and driving method of the SRM has been variously reported through several documents. In addition, according to the prior art, a method of finding an optimal geometric shape by a neural network algorithm has been introduced in order to reduce a torque ripple. They were suggested a design method of defining a stator and a rotor, which are mainly geometric parameters, as a design variable for reducing the torque ripple.

However, in the switched reluctance motor according to the prior art, since a torque is not generated in a continuous scheme by a rotor system, but a reluctance torque is used, high torque pulsation is generated, and significant noise and vibration is generated.

### SUMMARY OF THE INVENTION

The present invention has been made in an effort to provide a multi-phase switched reluctance motor apparatus generating a torque in a multi-phase excitation scheme to reduce torque pulsation, noise, and vibration.

The present invention also has been made in an effort to provide a control method of a multi-phase switched reluctance motor for generating a torque in a multi-phase excitation scheme.

According to a preferred embodiment of the present invention, there is provided a multi-phase switched reluctance motor apparatus including: a multi-phase switched reluctance motor; a position sensing sensor provided at one side of the multi-phase switched reluctance motor; and a controller connected to the multi-phase switched reluctance motor and the position sensing sensor and controlling power in a multi-phase excitation scheme according to a detection angle of the position sensing sensor to supply the power to the multi-phase switched reluctance motor.

The multi-phase switched reluctance motor may include: a rotor formed with a plurality of salient poles protruded along an outer peripheral surface thereof; and a stator rotatably receiving the rotor and including a plurality of phi (π)-shaped stator cores each facing the plurality of salient poles and having a coil wound therearound, and a magnetic path may be formed along the phi shaped stator core and the salient pole facing the phi shaped stator core.

The stator core may include: a yoke; and two stator salient poles protruded from both sides of the yoke so as to face the salient pole, and a cross section of the stator core orthogonal to a shaft may have a phi (π) shape.

The stator may further include an insulating part filled between the plurality of stator cores to fixedly couple the respective stator cores to each other.

The stator may further include a cooling part provided in the insulating part filled between the stator cores in order to radiate heat generated in the motor.

The rotor may include: a rotor core formed with a hollow hole to which a shaft is fixedly coupled; and the salient poles each protruded from an outer peripheral surface of the rotor core so as to face the stator core.

The stator may be provided so that a ratio of the number of stator salient poles to the number of salient poles of the rotor is 12:10.

The controller may be connected to the coils provided to each of the stator cores to control and supply power to at least one of the coils according to a detection rotation angle section of the position sensing sensor.

The position sensing sensor may include any one of an encoder, a resolver, and a potentiometer.

According to another preferred embodiment of the present invention, there is provided a control method of a multi-phase switched reluctance motor apparatus comprising: controlling selectively power using a torque distribution function (TDF) according to the detection rotation angle section of the position sensing sensor; and supplying the power to the multi-phase switched reluctance motor.

The step of supplying the power to the multi-phase switched reluctance motor further comprises: supplying the power to a coil provided to at least one stator core corresponding to a phase having a maximum torque or a minimum torque in each of a plurality of rotation angle sections divided from a rotation angle of a salient pole.

The controller may supply the power to the coil provided to at least one stator core corresponding to the phase having the maximum torque in each of the plurality of divided rotation angle sections when a torque command value (Tₑ*) satisfying a relationship of Tₑ*=Tₓ*+T_{y}* is a positive value.

The controller may supply the power to the coil provided to at least one stator core corresponding to the phase having the minimum torque in each of the plurality of divided rotation angle sections when a torque command value (Tₑ*) satisfying a relationship of Tₑ*=Tₓ*+T_{y}* is a negative value.

The plurality of divided rotation angle sections may be divided according to the number of salient poles or an advance angle value.

The TDF may be defined as

fₓ(θ)=gₓ²/(gₓ²+g_{y}²±2g_{xy}\sqrt{gₓg_{y}})

f_{y}(θ)=g_{y}²/(gₓ²+g_{y}²±2g_{xy}\sqrt{gₓg_{y}})

with respect to the plurality of stator cores (where gₓ(θ)≡∂Lₓ(θ)/∂θ, g_{y}(θ)≡∂L_{y}(θ)/∂θ, and g_{xy}(θ)≡∂M_{xy}(θ)/∂θ, L indicates self-inductance, M indicates mutual inductance, and θ indicates a rotation angle of the salient pole).

The control method of a multi-phase switched reluctance motor apparatus according to the preferred embodiment of the present invention may reduce a torque ripple rate (Tᵣᵢₚ) to ⅓ using the TDF as compared to the single-phase excitation driving method according to the prior art.

### BRIEF DESCRIPTION OF THE DRAWINGS

The above and other objects, features and advantages of the present invention will be more clearly understood from the following detailed description taken in conjunction with the accompanying drawings, in which:

FIGS. 1A and 1B are cross-sectional views schematically showing driving of a multi-phase switched reluctance motor according to a first preferred embodiment of the present invention;

FIG. 2 is a perspective view of the multi-phase switched reluctance motor shown in FIG. 1;

FIG. 3 is a cross-sectional view of a multi-phase switched reluctance motor according to a second preferred embodiment of the present invention;

FIG. 4 is a perspective view of the multi-phase switched reluctance motor shown in FIG. 3;

FIG. 5 is a cross-sectional view of a multi-phase switched reluctance motor according to a third preferred embodiment of the present invention;

FIG. 6 is a perspective view of the multi-phase switched reluctance motor shown in FIG. 5;

FIG. 7 is a graph describing a control method of a multi-phase switched reluctance motor apparatus according to the preferred embodiment of the present invention; and

FIGS. 8 to 10 are views describing a control method of a multi-phase switched reluctance motor apparatus according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

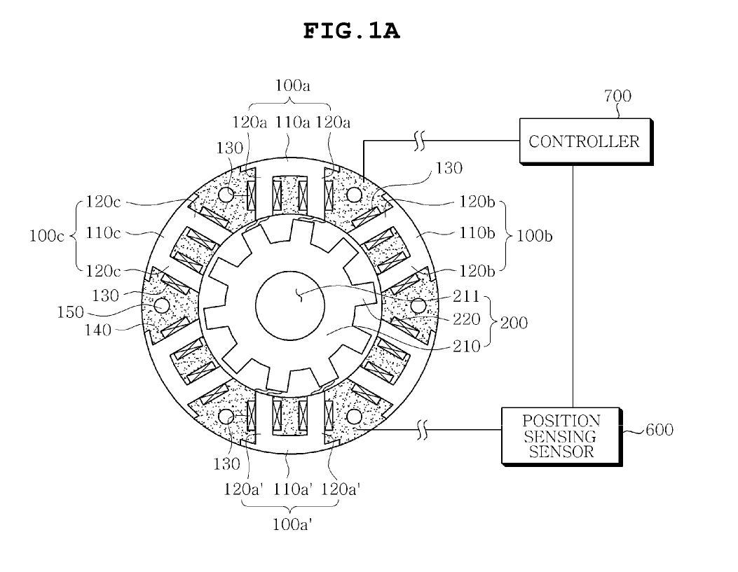

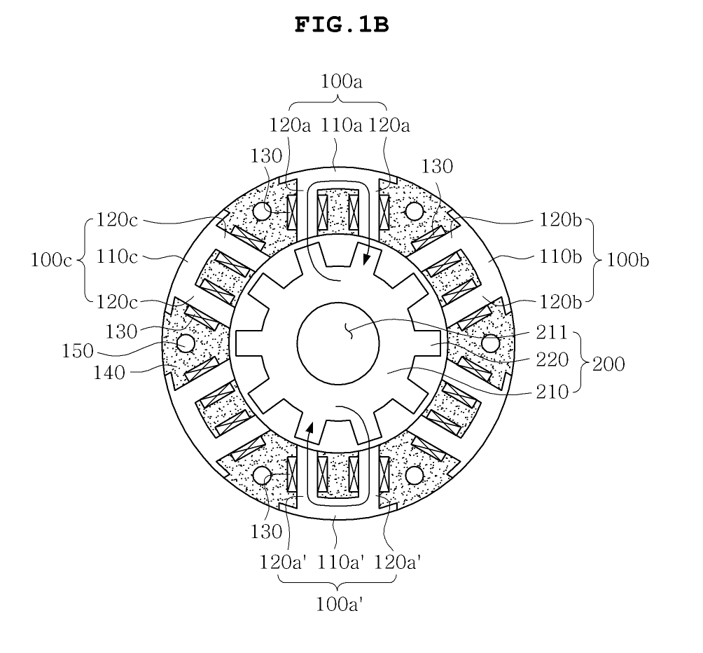

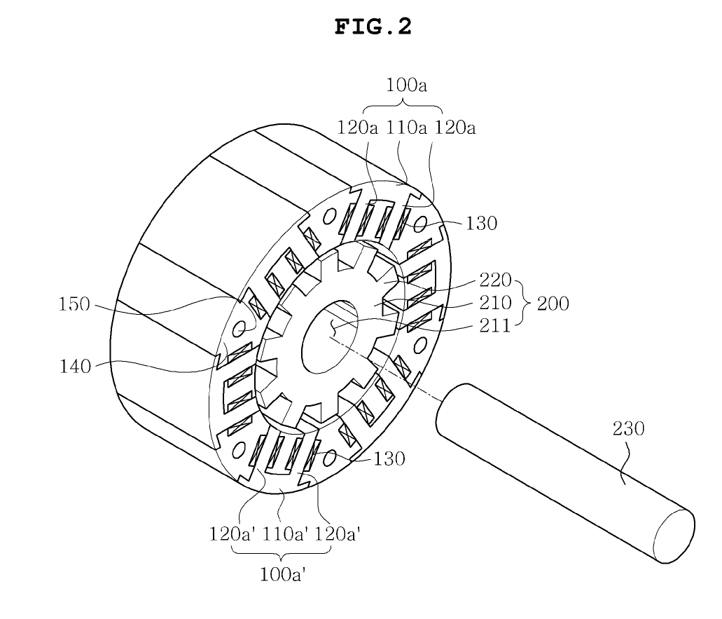

FIGS. 1A and 1B are cross-sectional views schematically showing driving of a multi-phase switched reluctance motor according to a first preferred embodiment of the present invention; and FIG. 2 is a perspective view of the multi-phase switched reluctance motor shown in FIG. 1.

The multi-phase switched reluctance motor apparatus according to the first preferred embodiment of the present invention is configured to include a multi-phase switched reluctance motor, a position sensing sensor 600 provided at one side of the multi-phase switched reluctance motor; and a controller 700 connected to the multi-phase switched reluctance motor and the position sensing sensor 600 and controlling power in a multi-phase excitation scheme according to a detection angle of the position sensing sensor to supply the power to the multi-phase switched reluctance motor.

The multi-phase switched reluctance motor according to the first preferred embodiment of the present invention includes a stator including a plurality of stator cores 100a, 100b, and 100c, and a rotor 200 having a reluctance torque generated due to magnetic force with the stator by a multi-phase excitation control method of the controller to rotate in one direction.

In detail, the rotor 200 includes a rotor core 210 and a plurality of salient poles 220. As shown in FIGS. 1A and 1B, a center of the rotor core 210 is formed with a hollow hole 211 to which a shaft 230 for transferring rotating force of the motor to the outside is fixedly coupled.

In addition, the multi-phase switched reluctance motor according to the first preferred embodiment of the present invention has a total of ten salient poles 220 protruded from an outer peripheral surface of the rotor core 210 as shown in FIGS. 1A and 1B. Here, according to the first preferred embodiment of the present invention, although the total number of salient poles 220 of the rotor 200 is ten, the number of salient poles 220 of the rotor 200 protruded from the rotor core 210 may also be ten or more.

In addition, the rotor core 210 and the salient poles 220 are made of a metal material in order to generate the reluctance torque.

The stator includes the plurality of stator cores 100a, 100b, and 100c, an insulating part 140, and a cooling part 150.

In detail, the stator core includes a first stator core 100a, a second stator core 100b, a third stator core 100c, and the respective corresponding stator cores corresponding thereto, and is arranged to have the entire cylindrical shape to thereby rotatably receive the rotor 200 at the center of the arrangement having the cylindrical shape.

Each of the stator cores 100a, 100b, and 100c has the same shape. Typically, the first stator core 100a includes a yoke 110a and a plurality of stator salient poles 120a.

In order for each of these stator cores 100a, 100b, and 100c to configure one phase, for example, the first stator core 100a and another stator core 100a′ may be disposed on the same line so as to face each other.

In detail, the yoke 110a is provided with two stator salient poles 120a, wherein the stator salient poles 120a are protruded inwardly from an inner peripheral surface of the yoke 110a so as to face the salient poles 220.

Therefore, a cross section of the yoke 110a and the stator salient poles 120a orthogonal to the shaft has a phi (π) shape or a Π shape.

According to the first preferred embodiment of the present invention, the plurality of stator cores 100a, 100b, and 100c have a phi (π) shape or a Π shape similar to each other.

In addition, according to the first preferred embodiment of the present invention that is to implement the multi-phase switched reluctance motor operated by a multi-phase excitation control method, a coil 130 to which power is applied from an external controller (not shown) by the multi-phase excitation control method is wound several times around each of the stator salient poles 120a, 120b, and 120c.

Further, the yoke 110a and the stator salient poles 120a are made of a metal material in order to generate the reluctance torque.

Further, as described above, since the multi-phase switched reluctance motor operated by the multi-phase excitation control method according to the first preferred embodiment of the present invention is configured of a three-phase stator core by forming one phase with each of the stator cores facing each of the stator cores 100a, 100b, and 100c so as to correspond to each of the stator cores 100a, 100b, and 100c, the stator includes a total of six stator cores having a phi (π) shape.

Therefore, the total number of stator salient poles 120a, 120b, and 120c is 12. In addition, although the multi-phase switched reluctance motor according to the first preferred embodiment of the present invention includes six stator cores having a phi shape so that a ratio of the number of stator salient poles 120 to the number of salient poles 220 of the rotor 200 is 12:10, the multi-phase switched reluctance motor may also include a plurality of stator cores having a phi shape so that a ratio of the number of stator salient poles to the number of salient poles of the rotor 24:20.

Further, an insulating part 140 is filled between the stator salient poles 120a configuring one stator core 100a and between the stator cores 100a, 100b, and 100c adjacent to each other.

In detail, according to the first preferred embodiment of the present invention, since the stator cores 100a, 100b, and 100c are separated from each other in a segment form, the insulating part 140 is filled in a space among the stator core 100a, the stator core 100b, and the stator core 100c in order to couple the stator cores to each other.

Further, according to the first preferred embodiment of the present invention, in order to block magnetic fluxes from moving among the stator cores 100a, 100b, and 100c, the insulating part 140 may be made of a resin material that is a non-magnetic material and an insulating material.

Therefore, in the case of the multi-phase switched reluctance motor according to the first preferred embodiment of the present invention, only a phi-shaped stator core in which a magnetic flux flows is formed of a metal material and the other portion is formed of an insulating part, thereby making it possible to reduce weight and a manufacturing cost of the stator, as compared to the switched reluctance motor in which the entire stator is made of a metal.

As shown in FIGS. 1A, 1B, and 2, since the multi-phase switched reluctance motor according to the first preferred embodiment generates heat due to driving for a long period of time, a cooling part 150 is implemented in the insulating part 140 provided between stator cores 100a, 100b, and 100c adjacent to each other in order to radiate the heat generated in the motor.

In detail, the cooling part 150 may be provided at a center portion of the insulating part 140 so as not to contact the coil 130 wound around the stator cores 100a, 100b, and 100c adjacent to each other.

In addition, the cooling part 150 according to the first preferred embodiment of the present invention may be a water cooling pipe. However, the cooling part 150 according to the first preferred embodiment of the present invention is not limited thereto, but may be a cooling part using other coolants.

Therefore, as shown in FIG. 1A, when power is applied to the coil 130, the reluctance torque is generated according to a change in magnetic reluctance. Then, the rotor 200 rotates toward the stator salient pole 120a of the phi-shaped stator core 100a closet thereto.

In this case, a magnetic flux flowing in the stator core 100a and the rotor 200 passes through the yoke 110a and two stator salient poles 120a that form a phi (π) shape, and the rotor 200, as shown in FIG. 1B.

In detail, the magnetic flux flows to one salient pole 220 facing one stator salient pole 120a, passes through the rotor core 210, flows to the other salient pole 220, and then passes through the other stator salient pole 120a.

As described above, in the multi-phase switched reluctance motor according to the first preferred embodiment of the present invention, the magnetic flux flows to the yoke 110a, thereby forming a magnetic flux path shorter than that of the switched reluctance motor according to the prior art.

Therefore, the magnetic flux path is shortened by the stator cores 100a, 100b, and 100c having the phi shape and the rotor 200 facing the stator cores 100a, 100b, and 100c, thereby making it possible to reduce core loss as compared with the switched reluctance motor of the prior art.

In addition, according to the first preferred embodiment of the present invention, only the phi shaped stator core in which the magnetic flux flows is made of a metal material and the other portion is made of an insulating material, thereby making it possible to reduce the weight and the manufacturing cost of the stator, as compared with the switched reluctance motor according to the prior art in which the entire stator is made of a metal.

The multi-phase switched reluctance motor according to the preferred embodiment of the present invention configured as described above includes the position sensing sensor 600 mounted at one side of the shaft and connected to the controller 700. Here, the position sensing sensor 600 is mounted with an encoder, a resolver, a potentiometer, or the like, that is generally used.

The controller 700 controls power according to each divided rotation angle range in a multi-phase excitation scheme to be described using rotation angle information detected through the position sensing sensor 600 to provide the power to the multi-phase switched reluctance motor according to the first preferred embodiment of the present invention.

The controller controls the power in the multi-phase excitation scheme as described above to provide the power, such that the multi-phase switched reluctance motor according to the first preferred embodiment of the present invention may generate a reluctance torque while reducing torque pulsation, noise, and vibration.

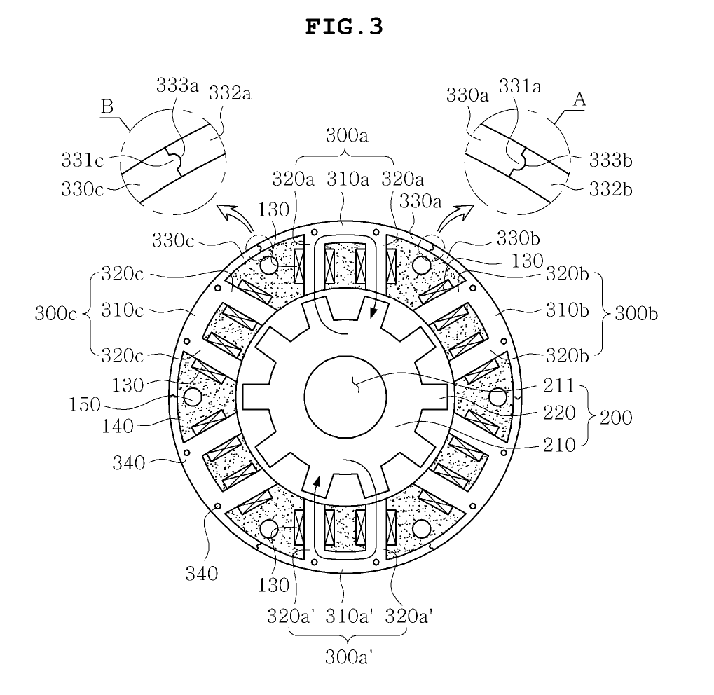

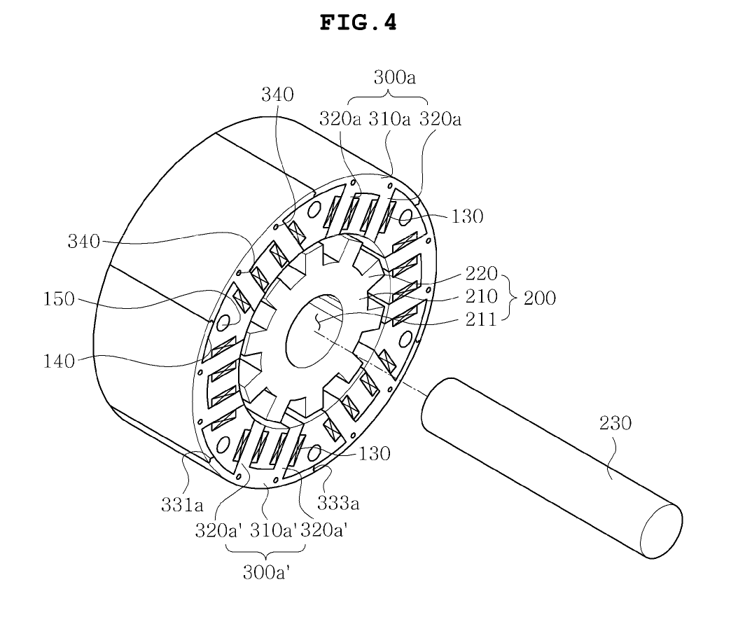

Hereinafter, a switched reluctance motor apparatus according to a second preferred embodiment of the present invention will be described with reference to FIGS. 3 and 4.

FIG. 3 is a cross-sectional view of a switched reluctance motor according to a second preferred embodiment of the present invention and FIG. 4 is a perspective view of the switched reluctance motor shown in FIG. 3. In describing the second preferred embodiment of the present embodiment, components that are equal or correspond to those of the first preferred embodiment of the present invention are denoted by the same reference numerals. In addition, a description of the overlapping portions will be omitted. Hereinafter, the switched reluctance motor according to the second preferred embodiment of the present invention will be described with reference to FIGS. 3 and 4.

The multi-phase switched reluctance motor apparatus according to the second preferred embodiment of the present invention is configured to include a multi-phase switched reluctance motor, a position sensing sensor provided at one side of the multi-phase switched reluctance motor; and a controller connected to the multi-phase switched reluctance motor and the position sensing sensor and controlling power in a multi-phase excitation scheme according to a detection angle of the position sensing sensor to supply the power to the multi-phase switched reluctance motor.

In the multi-phase switched reluctance motor according to the second preferred embodiment of the present invention, both ends 330a and 332a of one stator yoke 310a are extended toward ends 332b and 330c of stator yokes adjacent thereto to thereby be coupled to the ends 332b and 330c.

More specifically, at a portion “A” of FIG. 3, one end 330a of one stator yoke 310a is formed with a protrusion part 331a protruded outwardly, and the other end 332b thereof at an opposite side is formed with a coupling groove 333b engaged with and corresponding to a shape of the protrusion part 331a.

In addition, at a portion “B” of FIG. 3, a coupling groove 333a formed at the other end 332a of the stator yoke 310a is fitting-coupled to the protrusion part 331c formed at one end 330c of the stator yoke 310c adjacent to the stator yoke 310a adjacent to the stator yoke.

Therefore, as shown in enlarged “A” and “B” of FIG. 3, the stator core 300a is coupled to the stator cores 300b and 300c disposed at both sides thereof using the protrusion part 331a and the coupling groove 333a formed at the both ends 330a and 332a of the yoke 310a.

Therefore, in the case of the multi-phase switched reluctance motor according to the second preferred embodiment of the present invention, since the stator cores may be easily coupled to each other in a process of manufacturing the motor, a yield of assembling may be improved. Further, exchange or repair of the stator core due to damage during an operation of the motor may be facilitated.

Additionally, in the multi-phase switched reluctance motor according to the second preferred embodiment of the present invention, a plurality of blocking holes 340 for blocking a magnetic flux from moving from one stator yoke 310a toward the stator cores 300b and 300c coupled to both sides thereof are formed.

Therefore, as shown in FIG. 3, in the multi-phase switched reluctance motor according to the second preferred embodiment of the present invention, a magnetic flux path is configured only of the first stator core 300a and two salient poles 220 facing the first stator core 300a by a multi-phase excitation control method by the controller.

Further, the magnetic flux entering the yoke 310a from the salient pole 220 via the stator salient pole 320a flows in the blocking hole 340, thereby making it possible to obtain a short magnetic flux path.

Therefore, the multi-phase switched reluctance motor according to the second preferred embodiment of the present invention may shorten the magnetic flux path as compared to the switched reluctance motor according to the prior art and control the power in the multi-phase excitation scheme, thereby making it possible to generate a torque while reducing torque pulsation, noise, and vibration.

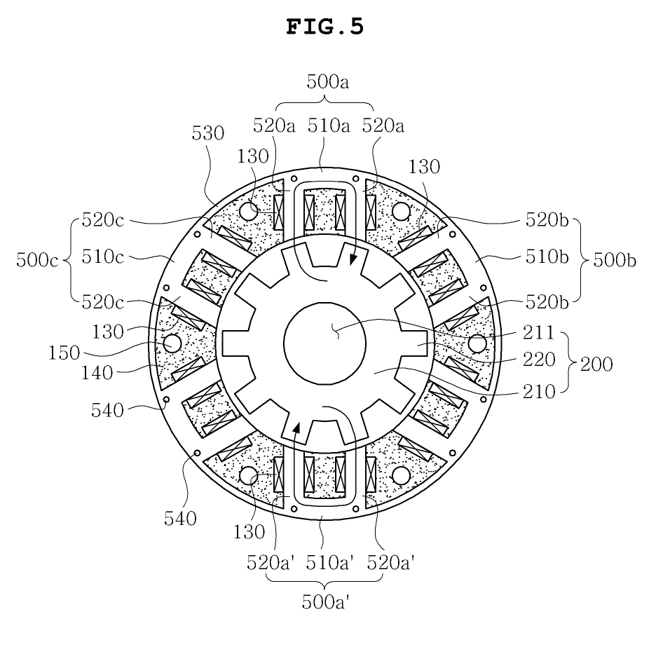

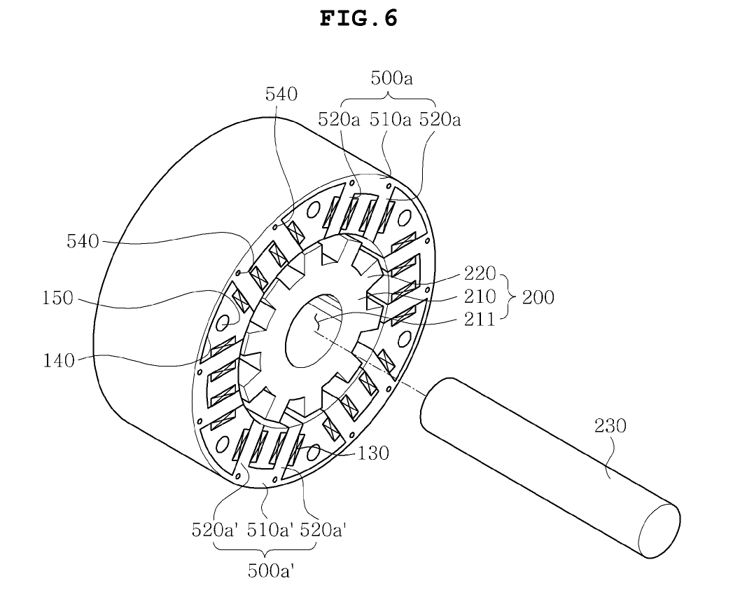

Hereinafter, a switched reluctance motor apparatus according to a third preferred embodiment of the present invention will be described with reference to FIGS. 5 and 6.

FIG. 5 is a cross-sectional view of a switched reluctance motor according to a third preferred embodiment of the present invention and FIG. 6 is a perspective view of the switched reluctance motor shown in FIG. 5. In describing the second preferred embodiment of the present embodiment, components that are equal or correspond to those of the above-mentioned embodiments of the present invention are denoted by the same reference numerals. In addition, a description of the overlapping portions will be omitted.

The multi-phase switched reluctance motor apparatus according to the third preferred embodiment of the present invention is configured to include a multi-phase switched reluctance motor, a position sensing sensor provided at one side of the multi-phase switched reluctance motor; and a controller connected to the multi-phase switched reluctance motor and the position sensing sensor and controlling power in a multi-phase excitation scheme according to a detection angle of the position sensing sensor to supply the power to the multi-phase switched reluctance motor.

As shown in FIG. 5, in the multi-phase switched reluctance motor apparatus according to the third preferred embodiment of the present invention, stator yokes 510a, 510b, and 510c adjacent to each other are connected integrally with each other to form a cylindrical outside 530, thereby making it possible to configure an integral stator.

Therefore, in the multi-phase switched reluctance motor according to the third preferred embodiment of the present invention, a plurality of stator cores 500a, 500b, and 500c having a phi (π) shape may be manufactured integrally with each other.

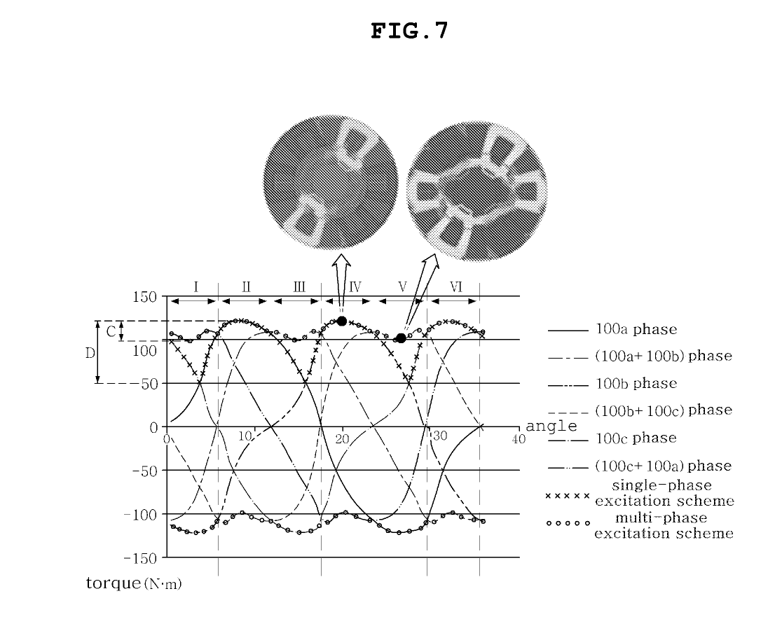

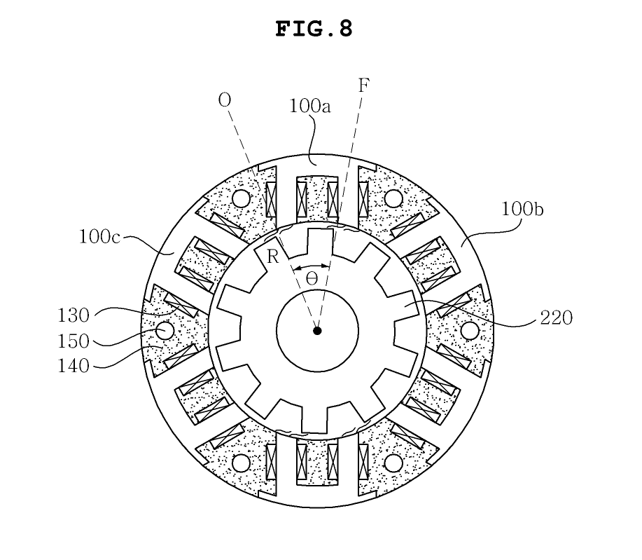

Hereinafter, a control method of a multi-phase switched reluctance motor apparatus according to a preferred embodiment of the present invention will be described with reference to FIGS. 7 to 10. FIG. 7 is a graph describing a control method of a multi-phase switched reluctance motor apparatus according to the preferred embodiment of the present invention; and FIGS. 8 to 10 are views describing a control method of a multi-phase switched reluctance motor apparatus according to the preferred embodiment of the present invention. Here, FIGS. 8 to 10 are view showing a modified example of the multi-phase switched reluctance motor shown in FIG. 1.

In the multi-phase switched reluctance motor capable of being variously implemented according to the first to third preferred embodiment of the present invention, power is selectively applied to the coil provided in at least one of the stator cores related to a corresponding phase according to each divided rotation angle range by the multi-phase excitation control method by the external controller, and the reluctance torque is generated according to a change in magnetic reluctance due to the application of the power.

In the multi-phase excitation control method according to the preferred embodiment of the present invention, a torque command value (Tₑ*) for two phase sections such as a first stator core 100a and a second stator core 100b adjacent to each other among the first stator core 100a, the second stator core 100b, and a third stator core 100c shown in FIG. 3 will be first defined.

The torque command value may be the sum of phase torque command values at two phases adjacent to each other, for example, a phase torque command value (Tₓ*) of the first stator core 100a and a phase torque command value (T_{y}*) of the second stator core 100b as represented by the following Equation 1.

Tₑ*=Tₓ*+T_{y}* [Equation 1]

With respect to Equation 1, in the case in which phase current (iₓ) applied to the coil 130 provided in the first stator core 100a and phase current (i_{y}) applied to the coil 130 provided in the second stator core 100b are maintained to be tolerance values or less for current command values (iₓ* and i_{y}*), that is, in the case in which it may be assumed that iₓ*≈iₓ and i_{y}*≈i_{y}, Equation 1 may be changed into Equation 2.

Tₑ*=(1/2)gₓ(iₓ*)²+(1/2)g_{y}(i_{y}*)²+g_{xy}iₓ*i_{y}*≈(1/2)gₓ(iₓ)²+(1/2)g_{y}(i_{y})²+g_{xy}iₓi_{y}≈Tₑ

In the case in which mutual inductance is also considered, a relationship of the following Equation 3 is satisfied.

Tₑ=Tₓ+T_{y}+T_{xy}

Tₓ=(1/2)gₓ(θ)iₓ²=fₓ(θ)Tₑ [Equation 3]

T_{y}=(1/2)g_{y}(θ)i_{y}²=f_{y}(θ)Tₑ

T_{xy}=g_{xy}(θ)iₓ_{y}=f_{xy}(θ)Tₑ

Where gₓ(θ)≡∂Lₓ(θ)/∂θ, g_{y}(θ)≡∂L_{y}(θ)/∂θ, and g_{xy}(θ)≡∂M_{xy}(θ)/∂θ, indicates self-inductance, M indicates mutual inductance, and 0 indicates a rotation angle of the salient pole 220.

A torque distribution function (TDF) of fₓ(θ), f_{y}(θ), and f_{xy}(θ) of Equation 3 satisfies a constrained condition of the following Equation 4.

fₓ(θ)+f_{y}(θ)+f_{xy}(θ)=1 [Equation 4]

(0≦fₓ(θ)≦1, fₓ(θ_{f})=0,0≦f_{y}(θ)≦2, f_{y}(θᵢ)=0, f_{y}(θ_{f})=1(θᵢ≦θ≦θ_{f}))

Although a TDF satisfying the above Equation may be defined in various forms, a TDF represented by the following Equation 5 according to the preferred embodiment of the present invention is defined.

fₓ(θ)=gₓ²/(gₓ²+g_{y}²±2g_{xy}\sqrt{gₓg_{y}})

f_{y}(θ)=g_{y}²/(gₓ²+g_{y}²±2g_{xy}\sqrt{gₓg_{y}}) [Equation 5]

Here, the phase current (iₓ) applied to the coil 130 provided in the first stator core 100a and the phase current (i_{y}) applied to the coil 130 provided in the second stator core 100b are calculated as represented by the following Equation 6.

$${i}_{x} = \sqrt{\frac{2 {g}_{x} {T}_{e}}{{g}_{x}^{2} + {g}_{y}^{2} \pm 2 {g}_{xy} \sqrt{{g}_{x} {g}_{y}}}} \\ {i}_{y} = \sqrt{\frac{2 {g}_{y} {T}_{e}}{{g}_{x}^{2} + {g}_{y}^{2} \pm 2 {g}_{xy} \sqrt{{g}_{x} {g}_{y}}}} \qquad [ Equation 6 ]$$

The multi-phase excitation control method optimized for this 12/10 multi-phase switched reluctance motor is implemented by dividing a rotation angle range between the salient poles into six angle sections and applying the TDF thereto.

In detail, since the 12/10 multi-phase switched reluctance motor has ten salient poles 220, the multi-phase excitation control method is implemented by uniformly dividing a 36 degree rotation angle region between continuous two salient poles 220 into six divided angle sections and applying to the TDF to each divided angle section.

Therefore, with respect to each of the case in which the torque command value (Tₑ*) is positive and the case in which the torque command value (Tₑ*) is negative, TDFs for each rotation angle section may be arranged as shown in Table 1 and Table 2. Here, the following Table 1 and Table 2 shows the case in which the rotation angle range is uniformly divided into six rotation angle sections by six degrees by way of example, but is not limited thereto. That is, the rotation angle range may also be divided into non-uniform rotation angle sections in consideration of the number of salient poles 220, an advance angle value, or the like, such that the sum of non-uniform rotation angle sections is 36 degrees.

TABLE 1

| | Rotation | | |
|---|---|---|---|
| | Angle Section | θᵢ = θ = θ_{f(deg)} | Tₑ* = 0 |
| fₐ | I | (0, 6) | gₐ²/(g_{c}² + gₐ² + 2 g_{ca}\sqrt{g_{c} gₐ}) |
| fₐ | II | (6, 12) | 1 |
| fₐ | III | (12, 18) | gₐ²/(gₐ² + g_{b}² + 2 g_{ab}\sqrt{gₐ g_{b}}) |
| fₐ | IV | (18, 24) | 0 |
| fₐ | V | (24, 30) | 0 |
| fₐ | VI | (30, 36) | 0 |
| f_{b} | I | (0, 6) | 0 |
| f_{b} | II | (6, 12) | 0 |
| f_{b} | III | (12, 18) | g_{b}²/(gₐ² + g_{b}² + 2 g_{ab}\sqrt{gₐ g_{b}}) |
| f_{b} | IV | (18, 24) | 1 |
| f_{b} | V | (24, 30) | g_{b}²/(g_{b}² + g_{c}² + 2 g_{bc}\sqrt{g_{b} g_{c}}) |
| f_{b} | VI | (30, 36) | 0 |
| f_{c} | I | (0, 6) | g_{c}²/(g_{c}² + gₐ² + 2 g_{ca}\sqrt{g_{c} gₐ}) |
| f_{c} | II | (6, 12) | 0 |
| f_{c} | III | (12, 18) | 0 |
| f_{c} | IV | (18, 24) | 0 |
| f_{c} | V | (24, 30) | g_{c}²/(g_{b}² + g_{c}² + 2 g_{bc}\sqrt{g_{b} g_{c}}) |
| f_{c} | VI | (30, 36) | 1 |

In Table 1 and Table 2, fₐ indicates a TDF regarding the first stator core 100a, f_{b} indicates a TDF regarding the second stator core 100b, and f_{c} indicates a TDF regarding the third stator core 100c.

TABLE 2

| | Rotation | | |
|---|---|---|---|
| | Angle Section | θᵢ = θ = θ_{f(deg)} | Tₑ* < 0 |
| fₐ | I | (0, 6) | 0 |
| fₐ | II | (6, 12) | 0 |
| fₐ | III | (12, 18) | 0 |
| fₐ | IV | (18, 24) | gₐ²/(gₐ² + g_{b}² − 2 g_{ab}\sqrt{gₐ g_{b}}) |
| fₐ | V | (24, 30) | 1 |
| fₐ | VI | (30, 36) | gₐ²/(g_{c}² + gₐ² − 2 g_{ca}\sqrt{g_{c} gₐ}) |
| f_{b} | I | (0, 6) | 1 |
| f_{b} | II | (6, 12) | g_{b}²/(g_{b}² + g_{c}² − 2 g_{bc}\sqrt{g_{b} g_{c}}) |
| f_{b} | III | (12, 18) | 0 |
| f_{b} | IV | (18, 24) | 0 |
| f_{b} | V | (24, 30) | 0 |
| f_{b} | VI | (30, 36) | g_{b}²/(gₐ² + g_{b}² − 2 g_{ab}\sqrt{gₐ g_{b}}) |
| f_{c} | I | (0, 6) | 0 |
| f_{c} | II | (6, 12) | g_{c}²/(g_{b}² + g_{c}² − 2 g_{bc}\sqrt{g_{b} g_{c}}) |
| f_{c} | III | (12, 18) | 1 |
| f_{c} | IV | (18, 24) | g_{c}²/(g_{c}² + gₐ² − 2 g_{ca}\sqrt{g_{c} gₐ}) |
| f_{c} | V | (24, 30) | 0 |
| f_{c} | VI | (30, 36) | 0 |

Results arranged in Table 1 and Table 2 may be represented by a torque graph shown in FIG. 7. Referring to this graph, in the multi-phase excitation control method according to the preferred embodiment of the present invention, when the torque command value (Tₑ*) is positive, the power is applied to the coil of the stator core corresponding to a phase having a maximum torque in each rotation angle section.

Meanwhile, in the multi-phase excitation control method according to the preferred embodiment of the present invention, when the torque command value (Tₑ*) is negative, the power is applied to the coil of the stator core corresponding to a phase having a minimum torque in each rotation angle section.

In detail, FIG. 8 showing a rotation angle initial state of 0 degree in a section “I” in the torque graph shown in FIG. 7 is referred.

As shown in FIG. 8, the salient pole 220 denoted by “R” is in a rotation angle initial state of 0 degree with respect to the first stator core 100a in the section “I” in the torque graph shown in FIG. 7, and the power is selectively applied to a (100c+100a) phase, that is, the third stator core 100c and the first stator core 100a, in which the salient pole 220 indicates a maximum reluctance torque in the section “I” up to a rotation angle of 6 degrees in a clockwise direction by the power applied to each coil 130 of stator cores corresponding thereto to generate a reluctance torque.

In a section “II”, the power is selectively applied only to a 100a phase, that is, the first stator core 100a, indicating a maximum reluctance torque and a coil 130 of a stator core corresponding thereto to generate the reluctance torque.

In a section “III”, the power is selectively applied only to a (100a+100b) phase, that is, the first stator core 100a and the second stator core 100b, indicating a maximum reluctance torque and each coil 130 of stator cores corresponding thereto to generate the reluctance torque.

In a section “IV”, the power is selectively applied only to a 100b phase, that is, the second stator core 100b, indicating a maximum reluctance torque and a coil 130 of a stator core corresponding thereto, such that current flows in the second stator core 100b and the stator core corresponding thereto as shown in an image on the graph, thereby generating the reluctance torque.

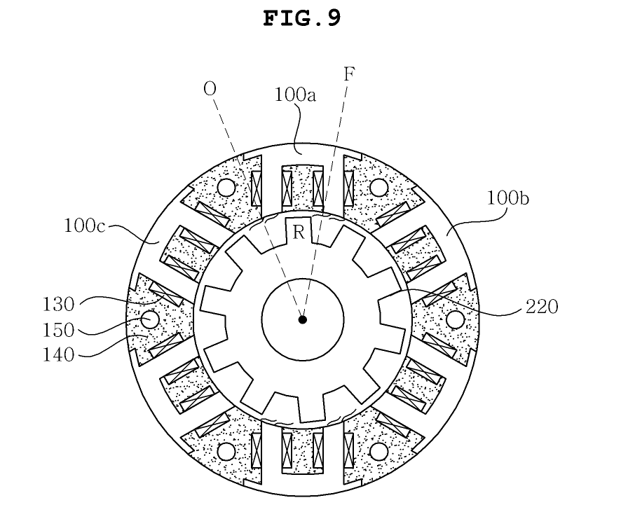

In a section “V”, as shown in FIGS. 7 and 9, the power is selectively applied only to a (100b+100c) phase, that is, the second stator core 100b and the third stator core 100c, indicating a maximum reluctance torque and each coil 130 of stator cores corresponding thereto, such that current flows in the second stator core 100b and the third stator core 100c and the stator cores corresponding thereto as shown in an image on the graph, thereby generating the reluctance torque.

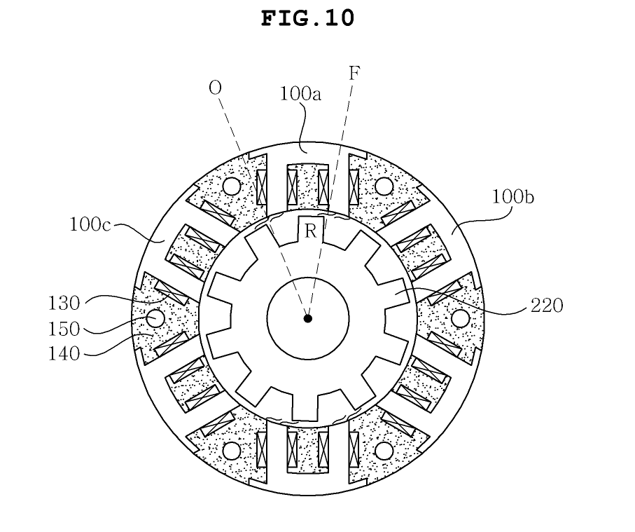

Further, in a section “VI”, as shown in FIGS. 7 and 10, the power is selectively applied only to a 100c phase, that is, the third stator core 100c, indicating a maximum reluctance torque and a coil 130 of a stator core corresponding thereto to generate the reluctance torque.

As described above, in the multi-phase excitation control method according to the preferred embodiment of the present invention, in the case in which the torque command value (Tₑ*) is positive, the power is selectively applied to the coil of the stator core corresponding to a phase having the maximum torque in each rotation angle section as in a portion “C” represented by “o o o o o” of FIG. 7 to generate the reluctance torque.

On the other hand, in the multi-phase excitation control method according to the preferred embodiment of the present invention, in the case in which the torque command value (Tₑ*) is negative, the power is selectively applied to the coil of the stator core corresponding to a phase having the minimum torque in each rotation angle section as in a portion represented by “o o o o o” at a lower portion of FIG. 7 to generate the reluctance torque in a counterclockwise direction.

An effect of the multi-phase excitation control method according to the preferred embodiment of the present invention may be compared with that of the single-phase excitation driving method according to the prior art using a torque ripple rate (Tᵣᵢₚ).

In detail, the torque ripple rate (Tᵣᵢₚ) is defined as represented by the following Equation 7.

$${T}_{rip} = \frac{{T}_{ma x} - {T}_{m i n}}{{T}_{ave}} \times 100 \\ {T}_{ave} = \frac{1}{2 π} {\int }_{0}^{2 π} τ d t \qquad [ Equation 7 ]$$

Where Tᵣᵢₚ indicates a torque ripple rate, Tₘₐₓ indicates a maximum torque, Tₘᵢₙ indicates a minimum torque, Tₐᵥₑ indicates an average torque, and τ indicates an instantaneous torque.

Comparing the multi-phase excitation control method according to the preferred embodiment of the present invention and the single-phase excitation driving method according to the prior art with each other according to Equation 7 related to the torque ripple rate (Tᵣᵢₚ), in a region “D” represented by “xxxxx” of FIG. 7 according to the single-phase excitation driving method according to the prior art, a torque ripple rate is 74%. However, in a region “C” of FIG. 7 according to the multi-phase excitation control method according to the preferred embodiment of the present invention, a torque ripple rate is reduced to 20%.

Therefore, it could be appreciated that a torque ripple rate (Tᵣᵢₚ) was reduced by ⅓ or more in the multi-phase excitation control method according to the preferred embodiment of the present invention as compared to the single-phase excitation driving method according to the prior art.

Therefore, the multi-phase excitation control method according to the preferred embodiment of the present invention reduces the torque ripple rate (Tᵣᵢₚ) as compared to the single-phase excitation driving method according to the prior art, thereby making it possible to reduce the torque pulsation, noise, and vibration.

As set forth above, the multi-phase switched reluctance motor according to the preferred embodiment of the present invention may generate the reluctance torque while reducing the torque pulsation, noise, and vibration.

In addition, the control method of a multi-phase switched reluctance motor apparatus according to the preferred embodiment of the present invention reduces the torque ripple rate to ⅓ as compared to the single-phase excitation driving method according to the prior art, thereby making it possible to reduce the torque pulsation, noise, and vibration.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A multi-phase switched reluctance motor apparatus comprising:
a multi-phase switched reluctance motor;
a position sensing sensor provided at one side of the multi-phase switched reluctance motor; and
a controller connected to the multi-phase switched reluctance motor and the position sensing sensor and controlling power in a multi-phase excitation scheme according to a detection angle of the position sensing sensor to supply the power to the multi-phase switched reluctance motor.

2. The multi-phase switched reluctance motor apparatus as set forth in claim 1, wherein the multi-phase switched reluctance motor includes:
a rotor formed with a plurality of salient poles protruded along an outer peripheral surface thereof and
a stator rotatably receiving the rotor and including a plurality of phi (π)-shaped stator cores each facing the plurality of salient poles and having a coil wound therearound, and
wherein a magnetic path is formed along the phi shaped stator core and the salient pole facing the phi shaped stator core.

3. The multi-phase switched reluctance motor apparatus as set forth in claim 2, wherein the stator core includes:
a yoke; and
two stator salient poles protruded from both sides of the yoke so as to face the salient pole, and
wherein a cross section of the stator core orthogonal to a shaft has a phi (π) shape.

4. The multi-phase switched reluctance motor apparatus as set forth in claim 2, wherein the stator further includes an insulating part filled between the plurality of stator cores to fixedly couple the respective stator cores to each other.

5. The multi-phase switched reluctance motor apparatus as set forth in claim 4, wherein the stator further includes a cooling part provided in the insulating part filled between the stator cores in order to radiate heat generated in the motor.

6. The multi-phase switched reluctance motor apparatus as set forth in claim 2, wherein the rotor includes:
a rotor core formed with a hollow hole to which a shaft is fixedly coupled; and
the salient poles each protruded from an outer peripheral surface of the rotor core so as to face the stator core.

7. The multi-phase switched reluctance motor apparatus as set forth in claim 2, wherein the stator is provided so that a ratio of the number of stator salient poles to the number of salient poles of the rotor is 12:10.

8. The multi-phase switched reluctance motor apparatus as set forth in claim 3, wherein both ends of the yoke are extended toward ends of yokes adjacent thereto and the ends of the yokes extended to face each other are fitting-coupled to each other, respectively.

9. The multi-phase switched reluctance motor apparatus as set forth in claim 8, wherein one end of the yoke is formed with a protrusion part protruded outwardly, and the other end thereof is formed with a coupling groove fitting-coupled to the protrusion part formed at one end of the yoke adjacent to the yoke.

10. The multi-phase switched reluctance motor apparatus as set forth in claim 2, wherein the controller is connected to the coils provided to each of the stator cores to control and supply power to at least one of the coils according to a detection rotation angle section of the position sensing sensor.

11. The multi-phase switched reluctance motor apparatus as set forth in claim 1, wherein the position sensing sensor includes any one of an encoder, a resolver, and a potentiometer.

12. A control method of a multi-phase switched reluctance motor apparatus according to claim 2, comprising:
controlling selectively power using a torque distribution function (TDF) according to the detection rotation angle section of the position sensing sensor; and
supplying the power to the multi-phase switched reluctance motor.

13. The control method as set forth in claim 12, wherein the supplying the power further comprises:
supplying the power to a coil provided to at least one stator core corresponding to a phase having a maximum torque or a minimum torque in each of a plurality of rotation angle sections divided from a rotation angle of a salient pole.

14. The control method as set forth in claim 13, wherein the supplying the power further comprises:
supplying the power to the coil provided to at least one stator core corresponding to the phase having the maximum torque in each of the plurality of divided rotation angle sections when a torque command value (Tₑ*) satisfying a relationship of Tₑ*=Tₓ*+T_{y}* is a positive value (where Tₓ* indicates a phase torque command value of any one of the stator cores, and T_{y}* indicates a phase torque command value of a stator core adjacent to the stator core corresponding to the Tₓ*).

15. The control method as set forth in claim 13, wherein the supplying the power further comprises:
supplying the power to the coil provided to at least one stator core corresponding to the phase having the minimum torque in each of the plurality of divided rotation angle sections when a torque command value (Tₑ*) satisfying a relationship of Tₑ*=Tₓ*+T_{y}* is a negative value (where Tₓ* indicates a phase torque command value of any one of the stator cores, and T_{y}* indicates a phase torque command value of a stator core adjacent to the stator core corresponding to the Tₓ*).

16. The control method as set forth in claim 13, wherein the plurality of divided rotation angle sections are divided according to the number of salient poles or an advance angle value.

17. The control method as set forth in claim 12, wherein the TDF is defined as
fₓ(θ)=fₓ²/(gₓ²+g_{y}²±2g_{xy}\sqrt{gₓg_{y}})
f_{y}(θ)=fₓ²/(gₓ²+g_{y}²±2g_{xy}\sqrt{gₓg_{y}})
plurality of stator cores (where gₓ(θ)≡∂Lₓ(θ)/∂θ, g_{y}(θ)≡∂L_{y}(θ)/∂θ, and g_{xy}(θ)≡∂M_{xy}(θ)/∂θ, L indicates self-inductance, M indicates mutual inductance, and 0 indicates a rotation angle of the salient pole).
